(19) United States
(12) Patent Application Publication
(10) Pub. No.: US 2010/0034512 A1
(43) Pub. Date: Feb. 11, 2010

(54) CONTENT RECORDING/REPRODUCING APPARATUS, METHOD, AND PROGRAM

(76) Inventors: Kunihiro Okamoto, Osaka (JP); Katsushi Ohizumi, Osaka (JP); Shuichi Watanabe, Osaka (JP)

Correspondence Address: BIRCH STEWART KOLASCH & BIRCH, PO BOX 747, FALLS CHURCH, VA, 22040-0747, US

(21) Appl. No.: 12/514,252

(22) PCT Filed: Nov. 7, 2007
(86) PCT No.: PCT/JP2007/071632

§ 371 Date: May 8, 2009

(30) Foreign Application Priority Data
Dec. 4, 2006 (JP) 2006-326448

(51) Int. Cl. H04N 5/91

(52) U.S. Cl. 386/83; 386/E05.003

(57) ABSTRACT

A content recording/reproducing apparatus capable of reproducing a content in accordance with the scheduled viewing time of a user without any interruption in the middle. A recording/reproducing apparatus (1) records reproduction time information indicating time required for the reproduction of each content to be accumulated in a accumulating portion (15) and records a content to be partially viewed out of the contents accumulated in the accumulating portion (15) and a part to be viewed out of the content as partial viewing information (for example, information unviewed or to be reviewed) on the accumulating portion (15). A time specifying portion (11) allows the user to set viewing time indicating the desired number of hours to view the content. A program selecting portion (14) extracts a reproduction content candidate so as to fall within the set viewing time by referencing to the reproduction time information and the partial viewing information from the content accumulated in the accumulating portion (15) and generates a list of the reproduction.

### TECHNICAL FIELD

The present invention relates to a content recording/reproducing apparatus, method, and program, and, more particularly, to a content recording/reproducing apparatus, content recording/reproducing method, and program to be installed in the apparatus, capable of reproducing content in accordance with a reproduction list.

### BACKGROUND OF THE INVENTION

Conventionally, such content as movies, news programs, drams, sport programs, and music programs are broadcasted by television broadcasting and radio broadcasting or distributed through a recording medium, such as a video cassette tape, DVD (Digital Versatile Disc), CD (Compact Disc), and BD (Blu-ray Disc). In recent years, forms of broadcasting programs have been increasing and the types and capacities of circulating recording media have been increasing as well. Hence even large-capacity content are now delivered to viewers/listeners. In addition, recent development of information processing equipment and network technology has lead to distribution of content to viewers/listeners through network-based communication.

Content distributed by broadcasting or via a network are recorded on a memory device, such as a hard disc, or on the above portable recording medium by using a video-recording apparatus, such as a hard disc recorder and various media recorders. By recording and accumulating a multiplicity of content including broadcast programs on a video-recoding apparatus, a user is able to freely reproduce content later to view/listen the content any time.

A viewer/listener may fail to view or listen broadcast content provided typically by television broadcasting and radio broadcasting at the time of broadcasting the content because of the viewer/listener's inconvenience. A video-recording apparatus has a reservation audio-recoding function and a reservation video-recording function for enabling the viewer/listener to compensate such an inconvenience. Using these reservation recording functions, the user finds out broadcast content to be recorded and reserved, referring to various media and an electronic program guide (EPG), to reserve the content, and the video-recoding apparatus receives the reservation made by the user, carries out a recording process in accordance with the reservation, thus accumulates the content in a memory device or a portable recording medium.

The video-recording apparatus also has a content reproducing function, being capable of outputting recorded/accumulated content to a built-in or externally attached display device and/or audio output device to reproduce the content thereon. Upon reproducing the content, the video-recording apparatus displays a list of accumulated content to allow the user to specify a content to view/listen among the listed content by selection operation. Such a list is a list of content to be reproduced, thus referred to as a reproduction list, and, in many cases, is a list of video-recorded content, thus referred also to as a video-recording list.

A technique of generating a reproduction list based on genres and user's tastes from accumulated content has been disclosed as a technique for reproduction list generation (see, e.g., Patent Documents 1 and 2). Patent Document 1 describes a music reproducing apparatus that makes a reproduction list in accordance with the types of musical compositions each specified for each time zone, based on the present time. Patent Document 2 describes a receiving apparatus that generates a reproduction list from programs broadcasted in real time and video-recorded programs, base on user's tastes and viewing/listening time zones.

### Patent Document 1: Japanese Laid-Open Patent Publication No. 2002-55993

### Patent Document 2: Japanese Laid-Open Patent Publication No. 2005-244472

### DISCLOSURE OF THE INVENTION

### Problems to be Solved by the Invention

When a viewer/listener actually views/listens content, a time for viewing/listening is often limited. In such a case, even if using the above reproduction list, the user eventually has to suspend viewing/listening. When suspending viewing/listening of content, the user may forget to view/listen the rest of content or may delete the content without viewing/listening.

The present invention was conceived in view of the above circumstances, and it is therefore an object of the present invention to provide a content recording/reproducing apparatus, content recording/reproducing method, and program to be installed in the apparatus, capable of reproducing content in adjustment to a user's viewing/listening scheduled time without suspending content reproduction.

### Means for Solving the Problems

In order to solve the above problem, the present invention is configured by the following technical means.

A first technical means is a content recording/reproducing apparatus having a content accumulating means that records and accumulates content and a content reproducing means that reproduces accumulated content accumulated in the content accumulating means, comprising: a reproducing time recording means that records reproducing time information indicative of a time needed for reproduction for each of the accumulated content; a partial viewing/listening information recording means that records a content to be partially viewed/listened among the accumulated content and a part of the partially viewed/listened content to be viewed/listened as partial viewing/listening information; a viewing/listening time setting means that allows a user to set a viewing/listening time representing a time span during which the user desires content viewing/listening; and a reproduction list generating means that extracts a reproduction candidate content referring to the reproduction time information and the partial viewing/listening information so that the reproduction candidate content falls within the viewing/listening time set by the viewing/listening time setting means to generate a reproduction list.

A second technical means is the content recording/reproducing apparatus as defined in the first technical means, wherein the partial viewing/listening information recording means includes a reviewing/relistening information recording means that allows a user to set reviewing/relistening information indicative of a content to be reviewed/relistened among the accumulated content and of a part of the reviewed/relistened content to be reviewed/relistened to record the reviewing/relistening information as the partial viewing/listening information.

A third technical means is the content recording/reproducing apparatus as defined in the first technical means, wherein the partial viewing/listening information recording means includes a nonreproducing information recording means that records nonreproducing information indicative of a nonreproduced part of each of accumulated content reproduced by the content recording/reproducing apparatus as the partial viewing/listening information.

A fourth technical means is the content recording/reproducing apparatus as defined in the first technical means, wherein the partial viewing/listening information recording means includes: a reviewing/relistening information recording means that allows a user to set reviewing/relistening information indicative of a content to be reviewed/relistened among the accumulated content and of a part of the reviewed/relistened content to be reviewed/relistened to record the reviewing/relistening information as one piece of the partial viewing/listening information; and a nonreproducing information recording means that records nonreproducing information indicative of a nonreproduced part of each of accumulated content reproduced by the content recording/reproducing apparatus as one piece of the partial viewing/listening information.

A fifth technical means is the content recording/reproducing apparatus as defined in any one of the first to fourth technical means, wherein the reproduction list generating means refers to the partial viewing/listening information in priority over the reproducing time information, to extract a reproduction candidate content among content indicated by the information referred to so that the reproduction candidate content falls within the viewing/listening time set by the viewing/listening time setting means.

A sixth technical means is the content recording/reproducing apparatus as defined in the fourth technical means, wherein the reproduction list generating means refers to the reproducing time information, the reviewing/relistening information, and the nonreproducing information in a given priority order, to extract a reproduction candidate content among content indicated by the information referred to so that the reproduction candidate content falls within the viewing/listening time set by the viewing/listening time setting means.

A seventh technical means is the content recording/reproducing apparatus as defined in any one of the first to sixth technical means, wherein the reproduction list generating means extracts in priority a content falling within the viewing/listening time and having a longer reproducing time as the reproduction candidate content.

A eighth technical means is the content recording/reproducing apparatus as defined in any one of the first to seventh technical means, comprising a list display means that displays the reproduction list generated by the reproduction list generating means and that checks with a user on whether or not to execute reproduction on the reproduction list, wherein the content reproducing means executes reproduction of content included in the reproduction list only when acquiring a confirmation of execution of the reproduction through the list display means.

A ninth technical means is the content recording/reproducing apparatus as defined in the eighth technical means, wherein the reproduction list generating means generates a plurality of the reproduction lists, wherein the list display means checks with a user on a reproduction list on which reproduction is to be executed among a plurality of reproduction lists generated by the reproduction list generating means, and wherein the content reproducing means executes reproduction of only the content included in the reproduction list on which execution of reproduction is confirmed through the list display means.

A tenth technical means is the content recording/reproducing apparatus as defined in any one of the first to ninth technical means, comprising a date/time recording means that records a recording date/time of recording of the partial viewing/listening information and/or a recording date/time of recording of the content itself, wherein the reproduction list generating means extracts in priority a content with a latest recording date/time recorded by the date/time recording means as the reproduction candidate content.

A eleventh technical means is the content recording/reproducing apparatus as defined in any one of the second to fourth technical means, comprising a date/time recording means that records a viewing/listening date/time of viewing/listening of the content indicated by the partial viewing/listening information, wherein the reproduction list generating means extracts in priority a content with a latest viewing/listening date/time recorded by the date/time recording means as the reproduction candidate content.

A twelfth technical means is the content recording/reproducing apparatus as defined in any one of the first to eleventh technical means, wherein the viewing/listening time setting means allows a user to set a time span the user desires content viewing/listening as the viewing/listening time together with information of a start time to start reproduction, and wherein the reproduction list generating means also extracts a content that is not accumulated in the content accumulating means at present and that is scheduled to be accumulated by the start time or by an end time given by adding the time span to the start time as the reproduction candidate content.

A thirteenth technical means is the content recording/reproducing apparatus as defined in the twelfth technical means, wherein the reproduction list generating means extracts in priority a content that is not accumulated in the content accumulating means at present and that is scheduled to be accumulated by the start time or by the end time as the reproduction candidate content.

A fourteenth technical means is a content recording/reproducing method in which a content reproducing means reproduces accumulated content accumulated in a content accumulating means, comprising the steps of: a reproducing time recording means recording reproducing time information indicative of a time needed for reproduction for each of the accumulated content; a partial viewing/listening information recording means recording a content to be partially viewed/listened among the accumulated content and a part of the partially viewed/listened content to be viewed/listened as partial viewing/listening information; a viewing/listening time setting means allowing a user to set a viewing/listening time representing a time span during which the user desires content viewing/listening; and reproduction list generating means extracting a reproduction candidate content among the accumulated content referring to the reproduction time information and the partial viewing/listening information so that the reproduction candidate content falls within the viewing/listening time set by the viewing/listening time setting means, to generate a reproduction list.

A fifteenth technical means is a program to be installed in a content recording/reproducing apparatus having a content accumulating means that records and accumulates content, and a content reproducing means that reproduces accumulated content accumulated in the content accumulating means, the program causing a processor in the content recording/reproducing apparatus to execute: a reproducing time recording step of recording reproducing time information indicative of a time needed for reproduction for each of the accumulated content; a partial viewing/listening information recording step of recording a content to be partially viewed/listened among the accumulated content and a part of the partially viewed/listened content to be viewed/listened as partial viewing/listening information; a viewing/listening time setting step of allowing a user to set a viewing/listening time representing a time span during which the user desires content viewing/listening; and a reproduction list generating step of extracting a reproduction candidate content among the accumulated content referring to the reproduction time information and the partial viewing/listening information so that the reproduction candidate content falls within the viewing/listening time set at the viewing/listening time setting step and generating a reproduction list.

### Effect of the Invention

The present invention enables reproduction of content in adjustment to a user's viewing/listening scheduled time without suspending content reproduction.

### BRIEF DESCRIPTION OF THE DRAWINGS

FIG. 1 is a block diagram of a configuration example of a recording/reproducing apparatus according to an embodiment of the present invention;

FIG. 2 is a diagram of an example of program information recorded on an accumulating portion in the recording/reproducing apparatus of FIG. 1;

FIG. 3 is a flow chart for explaining an example of a reproduction list generating process by the recording/reproducing apparatus of FIG. 1;

FIG. 4 is a diagram of an example of a reproduction list that is generated by the process of FIG. 3 referring to the program information of FIG. 2;

FIG. 5 is a flow chart for explaining another example of the reproduction list generating process by the recording/reproducing apparatus of FIG. 1;

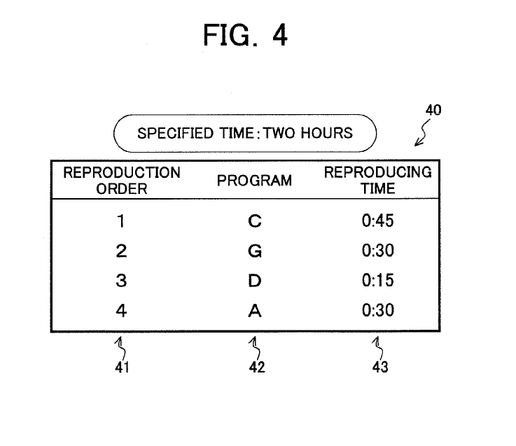

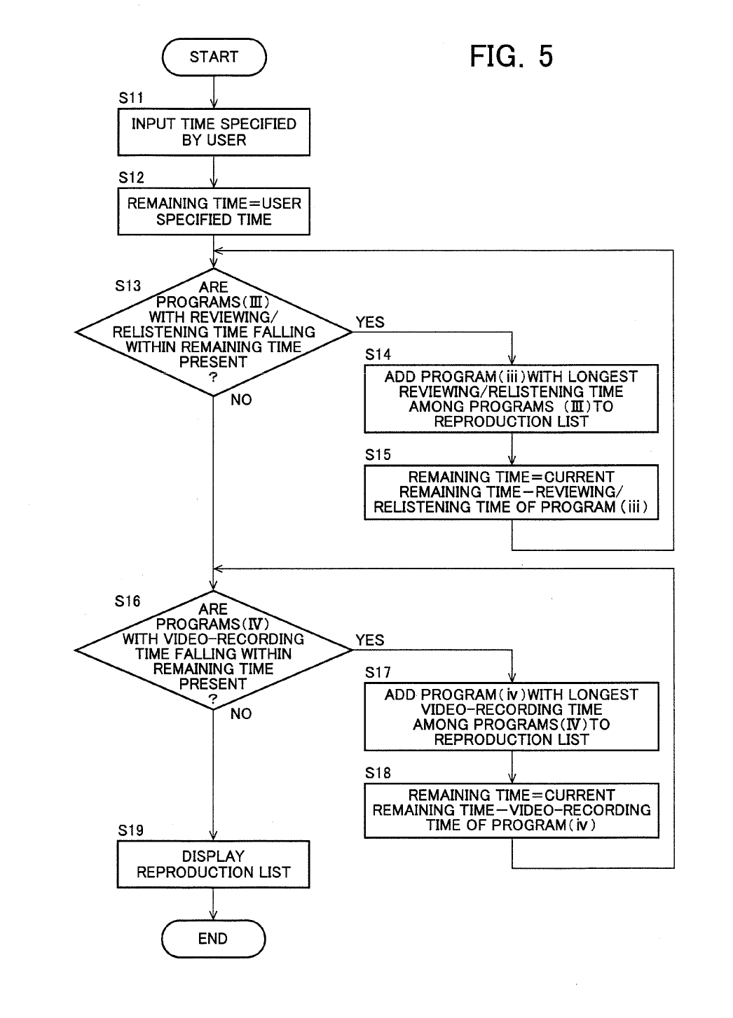

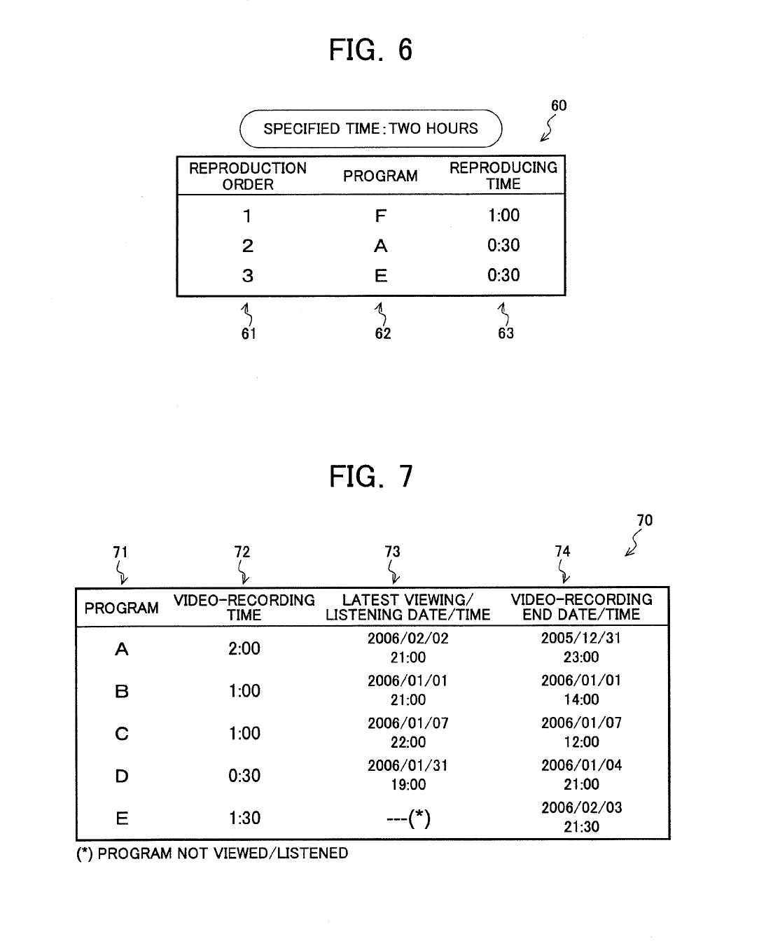

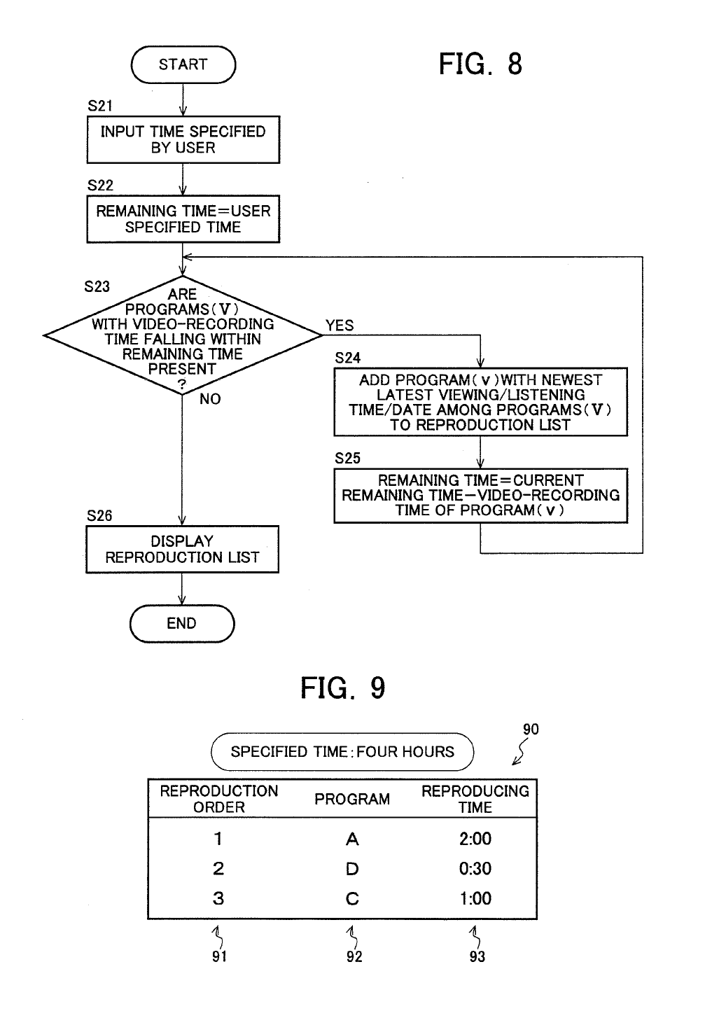

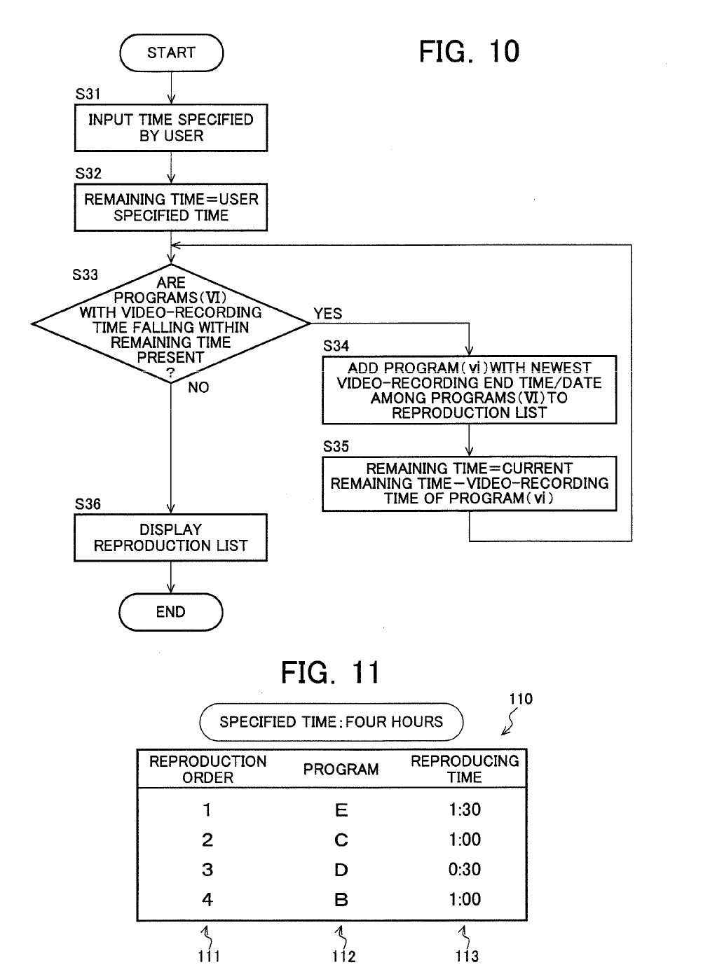

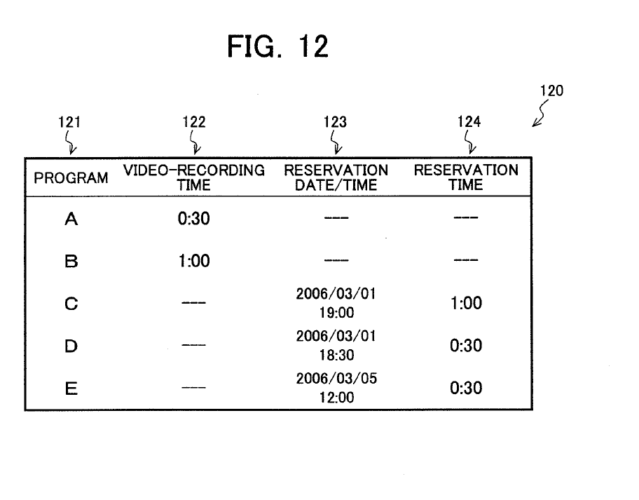

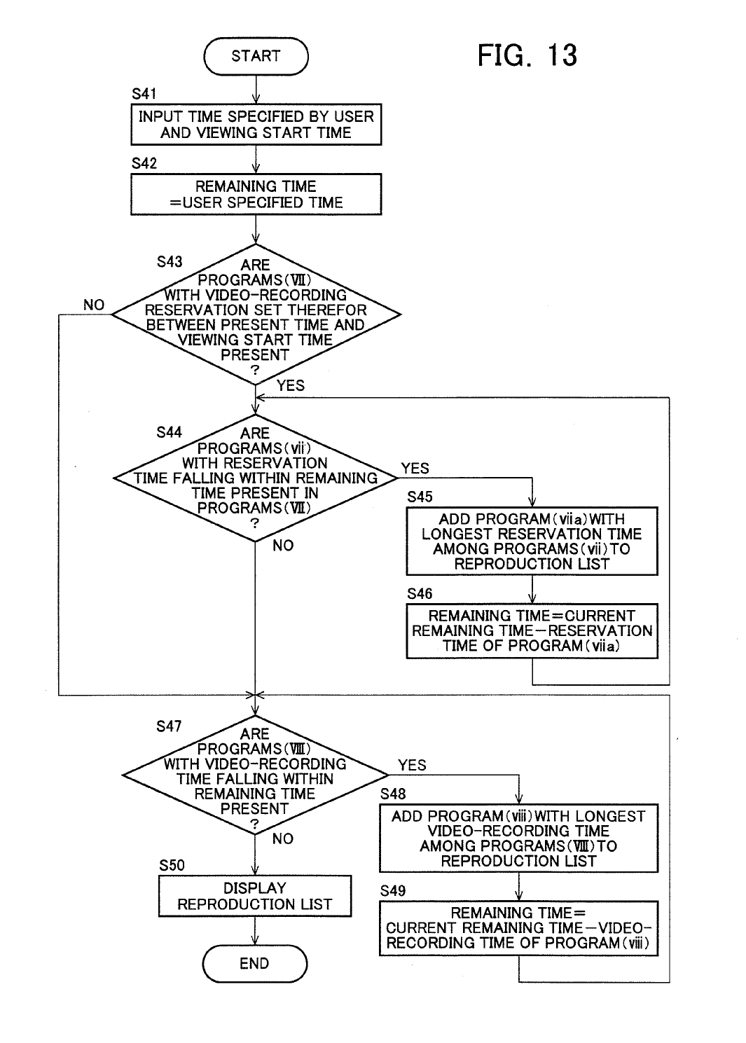

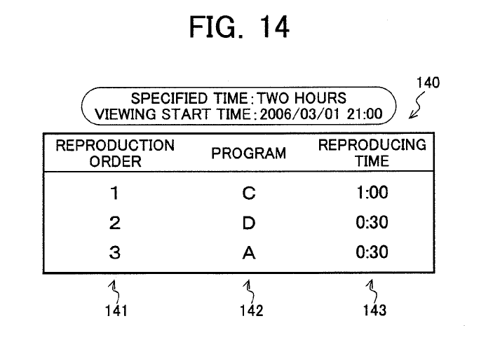

FIG. 4 is a diagram of an example of a reproduction list that is generated by the process of FIG. 5 referring to the program information of FIG. 2;

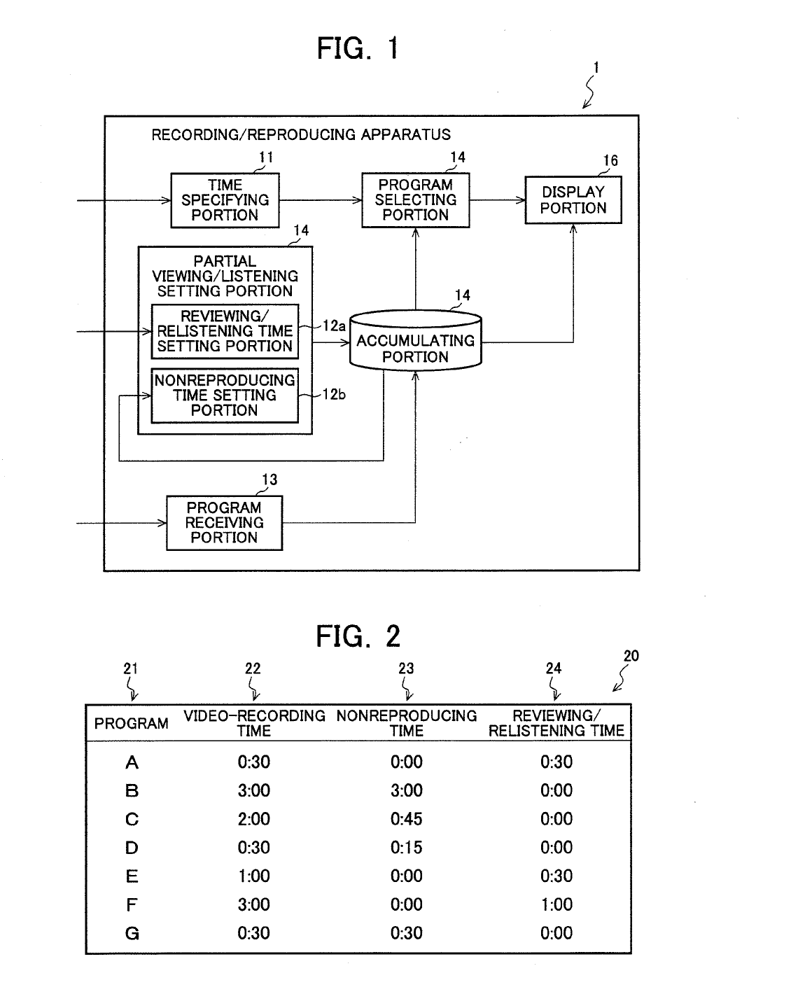

FIG. 7 is a diagram of another example of the program information recorded on the accumulating portion in the recording/reproducing apparatus of FIG. 1;

FIG. 8 is a flow chart for explaining still another example of the reproduction list generating process by the recording/reproducing apparatus of FIG. 1;

FIG. 9 is a diagram of an example of a reproduction list that is generated by the process of FIG. 8 referring to program information of FIG. 7;

FIG. 10 is a flow chart for explaining still another example of the reproduction list generating process by the recording/reproducing apparatus of FIG. 1;

FIG. 9 is a diagram of an example of a reproduction list that is generated by the process of FIG. 10 referring to the program information of FIG. 7;

FIG. 12 is a diagram of still another example of the program information recorded on the accumulating portion in the recording/reproducing apparatus of FIG. 1;

FIG. 13 is a flow chart for explaining still another example of the reproduction list generating process by the recording/reproducing apparatus of FIG. 1; and

FIG. 14 is a diagram of an example of a reproduction list that is generated by the process of FIG. 13 referring to the program information of FIG. 12.

### EXPLANATION OF REFERENCE NUMERALS

1 . . . recording/reproducing apparatus
11 . . . time specifying portion
12 . . . partial viewing/listening setting portion
12a . . . reviewing/relistening time setting portion
12b . . . nonreproducing time setting portion
13 . . . program receiving portion
14 . . . program selecting portion
15 . . . accumulating portion
16 . . . display portion

### PREFERRED EMBODIMENTS OF THE INVENTION

A content recording/reproducing apparatus of the present invention (hereinafter, simply referred to as “recording/reproducing apparatus”) includes a content accumulating means that records and accumulates content, and a content reproducing means that reproduces content (accumulated content) accumulated in the content accumulating means. The recording/reproducing apparatus is referred to as video-recording/reproducing apparatus when serving as an apparatus handling audio and video, and is referred to as audio-recording/reproducing apparatus when serving as an apparatus handling audio only. Hereinafter, the recording/reproducing apparatus will be described on the assumption that the recording/reproducing apparatus serves as a video-recording/reproducing apparatus, such as a recorder, that reproduces content and displays a reproduction list on an external display device. When the recording/reproducing apparatus serves as an audio-recording apparatus, reproduction list display according to the present invention is also carried out by a built-in display portion or an externally attached display device.

The recording/reproducing apparatus applies to, for example, an HDD recorder (digital broadcasting video-recording apparatus with a large-capacity storage) that has a digital broadcasting receiving tuner for ground-wave digital broadcasting, CS broadcasting, BD broadcasting, etc., and that is capable of accumulating such content as broadcast content, a digital broadcasting TV with a large-capacity storage, and other equipments having a tuner (which is unnecessary when only the accumulation-based input sources are handled), a content reproducing means, a content accumulating means, etc., such as a general-purpose computer with a tuner.

The content reproducing means is composed of a display device built in the recording/reproducing apparatus and a means that outputs content to the display device, or may be composed of a means that outputs content for viewing/listening to a display device outside the recording/reproducing apparatus. The content accumulating means is composed of a memory device, such as a hard disc (HDD), and a drive unit for such a removable portable recording medium as DVD, CD, and BD, etc. Content to be recorded can be acquired from one or a plurality of types of input sources, such as broadcasting-based input sources (various broadcasting waves) and accumulation-based input sources (distribution server, portable recording medium, etc.). In the following description, an example of a recording/reproducing apparatus that displays program content (hereinafter, simply referred to as “program”) acquired from broadcasting-based input sources on a display portion will be explained.

FIG. 1 is a block diagram of a configuration example of a recording/reproducing apparatus according to an embodiment of the present invention. In FIG. 1, 1 denotes the recording/reproducing apparatus. FIG. 2 is a diagram of an example of program information recorded on an accumulating portion in the recording/reproducing apparatus of FIG. 1. In FIG. 2, 20 denotes the program information.

In addition to the content accumulating means and the content reproducing means, the recording/reproducing apparatus 1 of the present invention also includes a reproducing time recording means, a partial viewing/listening information recording means (reviewing/relistening information recording means and/or nonreproducing information recording means, etc.), a viewing/listening time setting means, and a reproduction list generating means, which will be described later. The recording/reproducing apparatus 1 executes a reproduction list display process. In FIG. 1, the recording/reproducing apparatus 1 is depicted as an example of the recording/reproducing apparatus having the above means, which recording/reproducing apparatus 1 includes a time specifying portion 11, a partial viewing/listening setting portion 12 (reviewing/relistening time setting portion 12a and nonreproducing time setting portion 12b), and a program selecting portion 14 as the main features of the present invention, in addition to such ordinary constituent elements as a program receiving portion 13, an accumulating portion 15, and a display portion 16.

The means for executing the reproduction list display process of the present invention are composed of, for example, a user interface, such as an operation button that receives user operation, a CPU (Central Processor), a RAM (Random Access Memory), and a ROM (Read Only Memory) having recorded thereon a program (reproduction list generating program) that can be read out from the ROM to be executed by the CPU.

The program receiving portion 13 mainly carries out reception and demodulation of a broadcast signal, and is also capable of receiving EPG data. The accumulating portion 15 is an example of the content accumulating means, recording and accumulating program content (video-recording program data). A program received by the program receiving portion 13 is recorded on the accumulating portion 15 in accordance with video-recording operation (including reservation video-recording operation) by a user. The received program may be output directly to the display portion 16 to be reproduced in real time thereon.

The accumulating portion 15 functions also as part of the reproducing time recording means and the partial viewing/listening information recording means, thus serving as a recoding destination for both means to record and accumulate the program information 20 (including reproducing time information 22, reviewing/relistening time information 24, and/or nonreproducing information 23) of accumulated programs. The program information 20 may include viewing/listening analyzing data, etc., that is a record of a fact that a program has previously been viewed/listened, of user's taste in viewing/listening, etc.

The program selecting portion 14 is a portion that functions as the reproduction list generating means to generate a reproduction list, and will be described in detail later. The display portion 16 is a display device, such as a CRT (Cathode-Ray Tube), an LCD (Liquid Crystal Display), and a PDP (Plasma Display Panel), and displays content (video of a program in this example) and the reproduction list displayed by the program selecting portion 14.

The reproduction list generating process of the present invention will be described in detail. The reproducing time recording means is a means that records the reproducing time information 22 indicative of a time needed for reproduction for each of programs accumulated in the accumulating portion 15, and the accumulating portion 15 and the program receiving portion 13 are examples of the reproduction time recording means. The reproducing time information 22 is the information indicative of a reproducing time (video-recording time) to take for the whole of a recorded program. The reproducing time information 22 is acquired as a piece of content information. In an example of a broadcasting-based input resources that is now described, the reproduction time information 22 may be acquired as a piece of program information or a piece of EGP data from the program receiving portion 13. The reproducing time information 22 may be acquired as a time spent for video-recording (video-recording time) in the accumulating portion 15.

The partial viewing/listening information recording means is a means that records programs to be partially viewed/listened among programs accumulated in the accumulating portion 15 and the part of the programs to be viewed/listened as partial viewing/listening information. The partial viewing/listening information recording means should preferably have the reviewing/relistening information recording means and/or the nonreproducing information recording means, and records the reviewing/relistening information 24 and/or the nonreproducing information 23 as partial viewing/listening information, which will be described later.

The reviewing/relistening information recording means is a means that allows a user to set the reviewing/relistening information 24 indicative of programs to be reviewed/relistened among programs accumulated in the accumulating portion 15 and of the part of the programs to be reviewed/relistened, and that records the set reviewing/relistening information 24 as partial viewing/listening information. A reviewing/relistening time setting portion 12a and the accumulating portion 15 are examples of the reviewing/relistening information recording means. The reviewing/relistening information 24 is the information indicative of a reproducing time for reproducing a part of a program that the user has selected as the part to review desirably in future to carry out reviewing/relistening setting for the part.

The reviewing/relistening time setting portion 12a allows the user to set a reviewing/relistening time for a program, for example, by user operation of selecting a reviewing/relistening part. The accumulating portion 15 records the reviewing/relistening information 24 indicative of the set reviewing/relistening time. The reviewing/relistening information 24 is recorded in such a way that, for example, a flag is raised on a program to be reviewed/relistened and that a part to be reviewed/relistened is recorded as, for example, information of a period or information of a time indicated by the period (reviewing/relistening time).

The nonreproducing information recording means is a means that records the nonreproducing information 23 indicative of a nonreproducing part as partial viewing/listening information for each of programs accumulated in the accumulating portion 15 and reproduced by the recording/reproducing apparatus 1 in the past. The nonreproducing time setting portion 12b and the accumulating portion 15 are examples of the nonreproducing information recording means. The nonreproducing information 23 is the information indicative of a reproduction time for reproducing a part of a program that the user has not ever viewed/listened yet. When the user is in the middle of reviewing/relistening a program, the nonreproducing information 23 represents the information indicative of a reproduction time for reproducing a part of the program that the user has not viewed/listened yet in this reviewing/relistening.

When reproduction of a program is suspended in the middle of reproduction, the nonreproducing time setting portion 12b automatically detects the suspension and calculates a nonreproducing time (nonviewed/nonlistened time) from a position of detecting the suspension and a reproducing time for reproducing the whole program, while the accumulating portion 15 records the calculated nonviewed/nonlistened time as the nonreproducing information 23. The nonreproducing information 23 is recorded in such a way that, for example, when the user suspends reproduction of a program in the middle of reproduction, a flag is automatically raised on the program to point out the program as a program having a nonreproducing part and that the nonreproducing part is recorded as, for example, information of a period or information of a time indicated by the period (nonviewed/nonlistened time). The nonreproducing information 23 may include information that indicates the absence of a reproduced part in a program when the program has no reproduced part at all.

The viewing/listening time setting means is a means that allows the user to set a viewing/listening time representing a time span for viewing/listening content that the user desires. The time specifying portion 11 and the accumulating portion 15 are examples of the viewing/listening time setting means. The time specifying portion 11 allows the user to input a time span for viewing/listening (viewing/listening time) by selection or numeral entering, while the accumulating portion 15 temporarily saves the input viewing/listening time span to use it upon generating a reproduction list. Obviously, this time span is not specified only in hours, but also in minutes. The time span, therefore, may be specified as, for example, one hour and twenty minutes, ninety minutes, etc.

The time specifying portion 11 and the partial viewing/listening setting portion 12 are configured to include a remote controller serving as a user interface for carrying out user operation, and an operation button on the body side. Either or both of the remote controller and the operation button enable specifying and inputting a viewing/listening time and specifying and inputting a part to be reviewed/relistened. The time specifying portion 11 and the partial viewing/listening setting portion 12 are provided with a graphical user interface (GUI) for user input, and are configured to offer visual help that facilitate user input. The GUI is actually stored in the above ROM, etc., to be ready for execution.

A case is assumed where program names (or program IDs) 21 and programs indicated by the program names 21 (programs A to G) are recorded in the accumulating portion 15. In the above configuration, a reproducing time acquiring portion of the reviewing/relistening time setting portion 12a, the nonreproducing time setting portion 12b, and the program receiving portion 13 or a video-recording time counting portion of the accumulating portion 15 records the reproducing time (video-recording time) information 22, the nonreproducing information (nonviewing/nonlistening time) 23, and the reviewing/relistening information (reviewing/relistening time) 24 for each of the program names (A to G) 21 in, preferably, such a table format as the program information 20 of FIG. 2. For example, for a program E, a video-recording time is recorded as one hour, a nonviewing/nonlistening time is recorded as zero (none), and a reviewing/relistening time is recorded as thirty minutes on the table.

The reproduction list generating means extracts reproduction candidate programs among programs accumulated in the accumulating portion 15 referring to the reproducing time information 22 and partial viewing/listening information (reviewing/relistening information 24 and/or nonreproducing information 23, etc.) so that the reproduction candidate programs fall within the viewing/listening time set by the time setting portion 11, and generates a reproduction list consisting of the extracted programs. The program selecting portion 14 and the accumulating portion 15 are examples of the reproduction list generating means. The program selecting portion 14 selects one or a plurality of programs among programs accumulated in the accumulating portion 15, referring to the information 22 to 24 (program information 20) accumulated in the accumulating portion 15, to generate a reproduction list consisting of the selected programs preferably in a dynamic manner. The reproduction list may be generated in such a way that a program is added to the list every time the program is newly extracted.

In this manner, the program selecting portion 14 selects programs from the accumulating portion 15 so that a viewing/listening time for the selected programs does not exceed the viewing/listening time specified by the user, and generates a reproduction list. The generated reproduction list is displayed by the list display means to be presented to the user. The display portion 16 is an example of the list display means, and displays the reproduction list in the form of OSD data, etc.

The display portion 16, which is one of the content reproducing means, reproduces and displays the video of a program on the reproduction list that is selected by the user, and reproduces and outputs the audio of the program on an audio output portion (not shown), such as a speaker, which is one of the content reproducing means as the display portion 16 is. On the reproduction list, a reproduction order is set in accordance with an extraction order.

When displaying a reproduction list, the display portion 16 may output a screen or a voice that checks with the user on whether or not to execute reproduction on the reproduction list. Only when having the confirmation of execution of the reproduction on the list display means, the content reproducing means reads out programs contained in the reproduction list from the accumulating portion 15 to sequentially reproduce the readout programs.

The program selecting portion 14 may generate a plurality of reproduction lists, and the list display means may output a screen or a voice that checks with the user on a reproduction list for executing reproduction among the generated plurality of reproduction lists. Each of the generated reproduction lists may consist of programs totally different from programs on other lists, or may include some programs overlapping programs on other lists. The content reproducing means reads out programs from only the reproduction list that is confirmed as the list for executing reproduction by the list display means, thus reads out programs included in such a list from the accumulating portion 15, and sequentially reproduce the readout programs.

According to this embodiment, the user is allowed to specify a time for viewing/listening in advance, and programs to be reproduced are selected so that a viewing/listening time for the programs does not exceed the specified time input by the user, that is, the total viewing/listening time does not exceed the specified time, to generate a reproduction list. This enables reproduction of a program without suspension of the reproduction in adjustment to a viewing/listening scheduled time of the user. In other words, by specifying a time in advance, a limited time is used effectively without loss to carry out reproduction of a program without causing half-finished reproduction. When time information is input, several combinations of schedules of reproducing programs from accumulated programs within a specified time are presented. The schedules are made so that programs to be reproduced are selected and that the selected programs are reproduced in the order of selection. In this respect, the reproduction list display process executed in the present invention may be referred to as “recommended schedule reproduction” process.

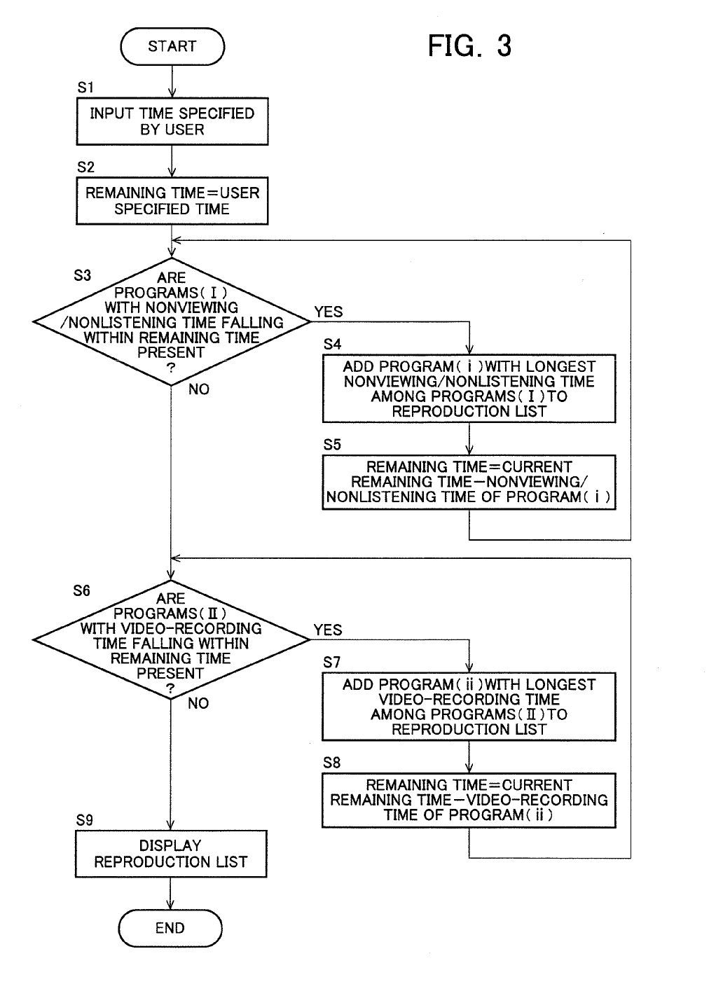

FIG. 3 is a flow chart for explaining an example of a reproduction list generating process by the recording/reproducing apparatus of FIG. 1, and FIG. 4 is a diagram of an example of a reproduction list that is generated by the process of FIG. 3 referring to the program information of FIG. 2. The reproduction list generating process using only the nonreproducing information (nonviewing/nonlistening time) 23 as partial viewing/listening information will be described with reference to FIGS. 3 and 4.

A time specified by a user is input to the time specifying portion 11, and the input time (viewing/listening time) is delivered to the program selecting portion 14 (step S1). The program selecting portion 14 takes the viewing/listening time (user specified time) to be a remaining time (step S2), and determines whether programs (I) with a nonviewing/nonlistening time falling within the remaining time are present (step S3). When the programs (I) are determined to be present at step S3, the program selecting portion 14 adds a program (i) with the longest nonviewing/nonlistening time among the programs (I) to a reproduction list (step S4), and corrects the remaining time into a remaining time given by subtracting the nonviewing/nonlistening time of the program (i) from the current remaining time (step S5), after which the process flow returns to step S3. In this process, when the specified time is two hours, the program C is selected first and then the programs G and D are selected in order from the programs A to G included in the program information 20 of FIG. 2. At this point of time, the remaining time is thirty minutes.

When the programs (I) are determined to be absent at step S3, the program selecting portion 14 determines whether programs (II) with a video-recording time falling within the remaining time are present (step S6). When the programs (II) are determined to be present at step S6, the program selecting portion 14 adds a program (ii) with the longest video-recording time among the programs (II) to the reproduction list (step S7), and corrects the remaining time into a remaining time given by subtracting the video-recording time of the program (ii) from the current remaining time (step S8), after which the process flow returns to step S6. Since the remaining time is now thirty minutes, the program A is selected in this process, at which point of time the remaining time is reduced to zero. While this flow chart shows a case where the remaining time is reduced to zero, the remaining time continues to exist in quite a few cases.

In this manner, program selection and addition to the reproduction list is repeated until a program with a nonviewing/nonlistening time not exceeding the remaining reproducing time runs out. When a program with a nonviewing/nonlistening time falling within the remaining reproducing time runs out and the reproducing time does not exceed the specified time, a program with a video-recording time not exceeding the remaining reproducing time is selected. As described at steps S4 and S7, it is preferable that the program selecting portion 14 extracts (i.e., addition to the reproduction list) in priority a program with a longer reproducing time falling within the viewing/listening time as the reproduction candidate program.

When the programs (II) are determined to be absent at step S6, the program selecting portion 14 outputs a reproduction list 40 to the display portion 16 to cause it to display the list 40 (step S9). The reproduction list 40 includes reproduction order 41, program name 42, and reproducing time 43, and may also include user specified time. When a program meeting both requirements of steps S3 and S6 is not present in the accumulating portion 15, the reproduction list is not made or a blank reproduction list is made and displayed. In the process following display of the reproduction list, programs included in the reproduction list are reproduced in order on the display portion 16, etc., without undergoing any check or after undergoing user check, as described above.

In this manner, in carrying out one of methods of selecting a program, a nonviewing/nonlistening time representing a time for a part of a program that the user has not viewed/listened yet is used, so that the nonviewing/nonlistening part can be incorporated into a reproduction schedule. This prevents the user from forgetting to view and listen a program, and allows the user to view and listen only the nonviewing/nonlistening part in an efficient manner.

FIG. 5 is a flow chart for explaining another example of the reproduction list generating process by the recording/reproducing apparatus of FIG. 1, and FIG. 6 is a diagram of an example of a reproduction list that is generated by the process of FIG. 5 referring to the program information of FIG. 2. The reproduction list generating process using only the reviewing/relistening information (reviewing/relistening time) 24 as partial viewing/listening information will be described with reference to FIGS. 5 and 6.

First, the process at steps S1 and S2 of FIG. 3 is executed (steps S11 and S12). The program selecting portion 14 then determines whether programs (III) with a reviewing/relistening time falling within the remaining time are present (step S13). When the programs (III) are determined to be present at step S13, the program selecting portion 14 adds a program (iii) with the longest reviewing/relistening time among the programs (III) to the reproduction list (step S14), and corrects the remaining time into a remaining time given by subtracting the reviewing/relistening time of the program (iii) from the current remaining time (step S15), after which the process flow returns to step S13. In this process, when the specified time is two hours, the program F is selected first and then the programs A and E are selected in order from the programs A to G included in the program information 20 of FIG. 2. At this point of time, the remaining time is thirty minutes.

When the programs (III) are determined to be absent at step S13, the program selecting portion 14 executes the process same as the process of steps S6 to S8 of FIG. 3 (steps S16 to S18). Because the remaining time is reduced to zero as a result of the process of steps S16 to S18, no program is selected. If the remaining time still exists and a program with a video-recording time shorter than the remaining time is present, however, that program is naturally selected.

In this manner, program selection and addition to the reproduction list is repeated until a program with a reviewing/relistening time not exceeding the remaining reproducing time runs out. When a program with a reviewing/relistening time falling within the remaining reproducing time runs out and the reproducing time does not exceed the specified time, a program with a video-recording time not exceeding the remaining reproducing time is selected. As described at steps S14 and S17, it is preferable that the program selecting portion 14 extract (i.e., addition to the reproduction list) in priority a program with a longer reproducing time falls within the viewing/listening time as the reproduction candidate program.

When the programs are determined to be absent at step S16, the program selecting portion 14 outputs a reproduction list 60 to the display portion 16 to cause it to display the list 60 (step S19). The reproduction list 60 includes reproduction order 61, program name 62, and reproducing time 63, and may also include user specified time. The process to be executed when a program meeting both requirements of steps S13 and S16 is not present in the accumulating portion 15 and the process following display of the reproduction list are equivalent to the process that has been described referring to FIG. 3.

In this manner, in carrying out one of methods of selecting a program, a reviewing/relistening time is set and used for scheduling when the user wants to review and relisten a program that has been viewed and listened before, so that the reviewing/relistening part can be incorporated into a reproduction schedule. This allows the user to efficiently view and listen only the reviewing/relistening part that the user wants to review and relisten.

When the reproduction list generating process using a nonviewing/nonlistening time that has been described in FIGS. 3 and 4 is combined with the reproduction list generating process using a reviewing/relistening time that has been described in FIGS. 5 and 6, the nonviewing/nonlistening time and the reviewing/relistening time are combined with a program to be selected to make a selection so that a resulting total time does not exceed the specified time. For example, steps S13 to S19 of FIG. 5 may be executed after steps S1 to S5 of FIG. 3. Contrary to that, steps S3 to S9 of FIG. 3 may be executed after steps S11 to S15 of FIG. 5. Which of the nonviewing/nonlistening time and the reviewing/relistening time is to be referred to in priority in program selection may be set by the user.

In both of the above examples, the partial viewing/listening information is referred to in priority over the reproducing time information to carry out program selection in a more preferred form, and a reproduction list enabling reproduction is generated in the order of reference priority in execution. The above order of reference to the partial viewing information and to the reproducing time information, however, may be determined to be in reverse.

FIG. 7 is a diagram of another example of the program information recorded on the accumulating portion in the recording/reproducing apparatus of FIG. 1. In another embodiment of the present invention, date/time information on a program, such as the video-recording date/time, the reviewing/relistening setting date/time, the viewing/listening date/time, and the number of viewing/listening of a program, may be used for selection of a program to be put on a reproduction list (to be incorporated into a schedule) in the recording/reproducing apparatus 1 of the above embodiments.

For that, the recording/reproducing apparatus 1 may include a date/time recording means that records the recording date/time of recording of the partial viewing/listening information (nonreproducing information and/or reviewing/relistening information, etc.) and/or the recording date/time of recording of the program itself. The accumulating portion 15 and the program receiving portion 13 are examples that include the date/time recording means. The program selecting portion 14 extracts in priority a program with the latest recording date/time recorded by the date/time recording means as the reproduction candidate program.

For example, the program selecting portion 14 may extract in priority a program with the latest recording date/time of the partial viewing/listening information recorded by the date/time recording means, or may extract in priority a program with the latest recording date/time (recording end date/time or recording start date/time) of the program itself recorded by the date/time recording means. The program selecting portion 14 may treat the recording date/time of the partial viewing/listening information and the recording date/time (recording end date/time or recording start date/time) of the program itself as the date/time of the same concept (i.e., date/time of the user's involvement in some form) to extract in priority a program with the latest date/time of the user's involvement.

The date/time recording means may be configured to be a means that records the viewing/listening date/time of viewing/listening of a program indicated by the partial viewing/listening information (a program indicated by the reviewing/relistening information and/or a program indicated by nonreproducing information). In this case, the program selecting portion 14 extracts in priority a program with the latest viewing/listening date/time recorded by the date/time recording means as the reproduction candidate program. “Viewing/listening date/time” can apply to a program that has at least been viewed and listened partially, and does not apply to a program that is not viewed and listened at all.

Not only a viewing/listening date/time but a viewing/listening frequency may also be recorded to extract in priority a program with greater viewing/listening frequency or a program with less viewing/listening frequency.

Program information 70 of FIG. 7 is an example that the viewing/listening date/time (latest viewing/listening time) of a program representing the date/time (time) of the user's latest viewing/listening of the program and the recording date/time (video-recording end time) of the program itself representing the date/time (time) of the end of recording the program are adopted from various forms of date/times and are accumulated in the accumulating portion 15. Naturally, even if other date/time information is adopted, the same process as the following process is carried out.

In this example, a case is assumed where program names (or program IDs) 71 and programs (programs A to E) indicated by the program names 71 are recorded on the accumulating portion 15. In the above configuration, a reproducing time acquiring portion of the program receiving portion 13 and a video-recording end date/time recording portion of the accumulating portion 15 record reproducing time information (video-recording time) 72, viewing/listening date/time information (latest viewing/listening date/time) 73, and video-recording date/time information (video-recording end date/time) 74 for each of the program names (A to E) 71 in, preferably, such a table format as the program information 70 of FIG. 7. For example, for a program C, a video-recording time is recorded as one hour, a latest viewing/listening date/time is recorded as 2006/01/07 22:00, and a video-recording end time is recorded as 2006/01/07 12:00 on the table. When nonviewing/nonlistening of a program is expressed, a space for the program is marked with a prescribed symbol, such as (*), or is left as a blank space. While the program information 70 presents an example of not including the nonreproducing information (nonviewing/nonlistening time) and the reviewing/relistening information (reviewing/relistening time), recording of information is carried out so that both information is included in the program information 70 as the need arises.

In these various forms, the programs A to E themselves included in the program information 70 are recorded and accumulated in the accumulating portion 15, and program information, such as the program information 70, is also recorded and accumulated in the accumulating portion 15 in a proper manner or through user input of a viewing/listening time from the time specifying portion 11. The program selecting portion 14 generates the reproduction list, based on the user specified viewing/listening time and the program information 70. This process of generating the reproduction list will be described using a process example with reference to FIGS. 8 and 9 and a process example with reference to FIGS. 10 and 11.

FIG. 8 is a flow chart for explaining another example of the reproduction list generating process by the recording/reproducing apparatus of FIG. 1, and FIG. 9 is a diagram of an example of a reproduction list that is generated by the process of FIG. 8 referring to the program information of FIG. 7. The reproduction list generating process using only the latest viewing/listening date/time as date/time information will be described with reference to FIGS. 8 and 9.

First, the process at steps S1 and S2 of FIG. 3 is executed (steps S21 and S22). The program selecting portion 14 then determines whether programs (V) with a video-recording time falling within the remaining time are present (step S23). When the programs (V) are determined to be present at step S23, the program selecting portion 14 adds a program (v) with the newest latest viewing/listening date/time among the programs (V) to the reproduction list (step S24), and corrects the remaining time into a remaining time given by subtracting the video-recording time of the program (v) from the current remaining time (step S25), after which the process flow returns to step S23. In this process, when the specified time is four hours, the program A is selected first and then the programs D and C are selected in order from the programs A to E included in the program information 70 of FIG. 7. At this point of time, the remaining time is thirty minutes.

In this manner, the program selecting portion 14 selects a program not exceeding the specified time and having a newer latest viewing/listening date/time among programs recorded on the accumulating portion 15 to add the selected program to the reproduction list, calculates a remaining reproducing time, and repeats program selection and addition to the reproduction list until a program not exceeding the remaining reproducing time runs out. As described at steps S24, it is preferable that the program selecting portion 14 extract (i.e., addition to the reproduction list) in priority a program that falls within the viewing/listening time and that has been viewed/listened most lately as the reproduction candidate program.

When the programs (V) are determined to be absent at step S23, the program selecting portion 14 outputs a reproduction list 90 to the display portion 16 to cause it to display the list 90 (step S26). The reproduction list 90 includes reproduction order 91, program name 92, and reproducing time 93, and may also include user specified time. The process to be executed when a program meeting the requirement of steps S23 is not present in the accumulating portion 15 and the process following display of the reproduction list are equivalent to the process that has been described referring to FIG. 3.

In this manner, in carrying out one of methods of selecting a program, a program that has been viewed/listened most lately is selected in priority and is used for scheduling, so that the user is allowed to view/listen the continuance of a program fresh in the user's memory without a long time interval. Conversely, selecting in priority a program that was viewed/listened in the farthest past allows the user to view/listen the continuance of a program that is about to disappear from the user's memory.

FIG. 10 is a flow chart for explaining another example of the reproduction list generating process by the recording/reproducing apparatus of FIG. 1, and FIG. 11 is a diagram of an example of a reproduction list that is generated by the process of FIG. 10 referring to the program information of FIG. 7. The reproduction list generating process using only the video-recording end date/time as date/time information will be described with reference to FIGS. 10 and 11.

First, the process at steps S1 and S2 of FIG. 3 is executed (steps S31 and S32). The program selecting portion 14 then determines whether programs (VI) with a video-recording time falling within the remaining time are present (step S33). When the programs (VI) are determined to be present at step S33, the program selecting portion 14 adds a program (vi) with the newest video-recording end date/time among the programs (VI) to the reproduction list (step S34), and corrects the remaining time into a remaining time that is given by subtracting the video-recording time of the program (vi) from the current remaining time (step S35), after which the process flow returns to step S33. In this process, when the specified time is four hours, the program E is selected first and then the programs C, D and B are selected in order from the programs A to E included in the program information 70 of FIG. 7. At this point of time, the remaining time is reduced to zero.

In this manner, the program selecting portion 14 selects a program not exceeding the specified time and having a newer video-recording end date/time among programs recorded on the accumulating portion 15 to add the selected program to the reproduction list, calculates a remaining reproducing time, and repeats program selection and addition to the reproduction list until a program not exceeding the remaining reproducing time runs out. As described at steps S34, it is preferable that the program selecting portion 14 extract (i.e., addition to the reproduction list) in priority a program that falls within the viewing/listening time and that has been video-recorded most lately as the reproduction candidate program.

When the programs (VI) are determined to be absent at step S33, the program selecting portion 14 outputs a reproduction list 110 to the display portion 16 to cause it to display the list 110 (step S36). The reproduction list 110 includes reproduction order 111, program name 112, and reproducing time 113, and may also include user specified time. The process to be executed when a program meeting the requirement of steps S33 is not present in the accumulating portion 15 and the process following display of the reproduction list are equivalent to the process that has been described referring to FIG. 3.

In this manner, in carrying out one of methods of selecting a program, a program that has been video-recorded most lately is selected in priority and is used for scheduling, so that the user is allowed to immediately view/listen a program that has been video-recorded lately. Conversely, selecting in priority a program that was viewed/listened in the farthest past allows the user to view/listen in priority a program older in recording.

When the reproduction list generating process using a latest viewing/listening date/time that has been described in FIGS. 8 and 9 is combined with the reproduction list generating process using a video-recording end date/time that has been described in FIGS. 10 and 11, those date/times are combined with a program to be selected to make a selection so that a resulting total time does not exceed a specified time. For example, steps S33 to S36 of FIG. 10 may be executed after steps S21 to S25 of FIG. 8. Contrary to that, steps S23 to S26 of FIG. 8 may be executed after steps S31 to S35 of FIG. 10. Which of the latest viewing/listening date/time and the video-recording end date/time is to be referred to in priority in program selection may be set by the user.

In the embodiment described with reference to FIGS. 7 to 11, a plurality of reproduction lists may be generated to allow user selection. In addition, a process as a combination of the embodiment described with reference to FIGS. 2 to 6 and the embodiment described with reference to FIGS. 7 to 11 may also be possible. In such a process, storing information necessary as program information in the accumulating portion 15 and determining the priority order of reference to items in the program information in advance allows extraction of a program and generation/display of a reproduction list in accordance with the priority order.

According to the recording/reproducing apparatus 1 of the above embodiments, only the programs that are already accumulated in the accumulating portion 15 at the time of the user's inputting a specified time (viewing/listening time) are the subject of a reproduction list. When programs are actually reproduced after the user also inputs a viewing/listening start time, however, the programs are reproduced one by one in sequence, which may lead to a situation where another program has newly been video-recorded at the point of time of finishing the reproduction of one program. It is therefore preferable in the present invention that a program with video-recording reservation set therefor be also the subject of the reproduction list, that is, video-recording reservation information be also referred to when the reproduction list is made. This embodiment will be described with reference to FIGS. 12 to 14.

FIG. 12 is a diagram of still another example of the program information recorded on the accumulating portion in the recording/reproducing apparatus of FIG. 1, FIG. 13 is a flow chart for explaining still another example of the reproduction list generating process by the recording/reproducing apparatus of FIG. 1, and FIG. 14 is a diagram of an example of a reproduction list that is generated by the process of FIG. 13 referring to the program information of FIG. 12.

For this embodiment, the viewing/listening time setting means of the recording/reproducing apparatus 1 may allow the user to set information of a start time (start date/time) of starting reproduction together with a time span as a viewing/listening time that the user desires viewing/listening a program. The program selecting portion 14 also extracts a program that is not accumulated in the accumulating portion 15 at present and that is scheduled to be accumulated by a start time or an end time (time given by adding the time span to the start time) as the reproduction candidate program. A program scheduled to be accumulated by the end time means a program scheduled to be accumulated before a lapse of the time span from the start time. Program extraction, therefore, may be executed based on a reference point of time in the middle of a lapse of the time span. The recording/reproducing apparatus 1 of this embodiment has a video-recording reservation function.

In the example of program information 120 of FIG. 12, a case is assumed where program names (or program IDs) 121 and programs (programs A to E) indicated by the program names 121 are recorded on the accumulating portion 15. In the above configuration, a start time/time span acquiring portion of the time specifying portion 11 and the reproducing time acquiring portion and a video-recording reservation making portion of the program receiving portion 13 record reproducing time information (video-recording time) 122, reservation date/time information (reservation date/time) 123, and reservation time information (reservation time) 124 for each of the program names (A to E) 121 in, preferably, such a table format as the program information 120 of FIG. 12. Reservation date/time means the date/time (time) of starting video-recording of a program, and reservation time means a reproducing (video-recording) time for a program with video-recording reservation set therefor. For example, for the program E, a video-recording time is recorded as zero (because the program E is not video-recorded when the reproduction list is generated), a reservation date/time is recorded as 2006/03/05 12:00, and a reservation time is recorded as thirty minutes on the table. While the program information 120 presents an example of not including the nonreproducing information (nonviewing/nonlistening time), the reviewing/relistening information (reviewing/relistening time), and the date/time information, recording of information is carried out so that the above information is included in the program information 120 as the need arises.

In the reproduction list generating process, the process at steps S1 and S2 of FIG. 3 is executed first (steps S41 and S42). At step S41, a viewing/listening start time input from the time specifying portion 11 by the user is received. The program selecting portion 14 then determines whether programs (VII) with video-recording reservation set therefor between the present time and the viewing/listening start time is present (step S43). When the programs (VII) are determined to be present at step S43, the process flow proceeds to step S44. When the programs (VII) are determined to be absent, the process flow jumps across steps S44 to S46 to step S47.

At step S44, the program selecting portion 14 determines whether programs (vii) with a reservation time falling within the remaining time is present in the programs (VII). When the programs (vii) are determined to be present at step S44, the program selecting portion 14 adds a program (viia) with the longest reservation time among the programs (vii) to the reproduction list (step S45), and corrects the remaining time into a remaining time given by subtracting the reservation time of the program (viia) from the current remaining time (step S46), after which the process flow returns to step S44. In this process, when the specified time is two hours and the viewing/listening start time is 2006/03/01 21:00, the program C is selected first and then the programs D is selected from the programs A to E included in the program information 120 of FIG. 12. At this point of time, the remaining time is thirty minutes.

When the programs (vii) are determined to be absent at step S44, the process flow proceeds to S47, at which the program selecting portion 14 determines whether programs (VIII) with a video-recording time falling within the remaining time are present (step S47). When the programs (VIII) are determined to be present at step S47, the program selecting portion 14 adds a program (viii) with the longest video-recording time among the programs (VIII) to the reproduction list (step S48), and corrects the remaining time into a remaining time given by subtracting the video-recording time of the program (viii) from the current remaining time (step S49), after which the process flow returns to step S47. In this process, the program A is selected first as the remaining time is thirty minutes, which reduces the remaining time to zero.

In this manner, the program selecting portion 14 first extracts programs with video-recording reservation set therefor between the present time and the viewing/listening start time, from the accumulating portion 15, and then selects a program not exceeding the specified time and having a longer reservation time among the extracted programs to add the selected program to the reproduction list. The program selecting portion 14 then calculates a remaining reproducing time, and repeats program selection and addition to the reproduction list until a program having a reservation time not exceeding the remaining reproducing time runs out. When a program with a reservation time falling within the remaining reproducing time runs out and the reproducing time does not exceed the specified time, a program with a video-recording time not exceeding the remaining reproducing time is then selected.

As described at steps S45 and S48, it is preferable that the program selecting portion 14 extract (i.e., addition to the reproduction list) in priority a program that falls within the viewing/listening time and that is the longest as the reproduction candidate program. As described at step S43, it is preferable that the program selecting portion 14 extract in priority a program that is not accumulated in the accumulating portion 15 at present and that is scheduled to be accumulated by the start time or the end time as the reproduction candidate program. Conversely, such a program may be omitted in priority from reproduction program candidates to be extracted.

When the programs (VIII) are determined to be absent at step S47, the program selecting portion 14 outputs a reproduction list 140 to the display portion 16 to cause it to display the list 140 (step S50). The reproduction list 140 includes reproduction order 141, program name 142, and reproducing time 143, and may also include user specified time and viewing/listening start time. The process to be executed when a program meeting the requirement of both steps S44 and S47 is not present in the accumulating portion 15 and the process following display of the reproduction list are equivalent to the process that has been described referring to FIG. 3.

The program information 120 of FIG. 12 presents an example of not including a program of which reserved video-recording is in progress in the period between a viewing/listening start time and a viewing/listening end time (2006/03/01 23:00). Such a program of which reserved video-recording is in progress (e.g., program Z with a reservation date/time of 2006/03/01 22:00 and with a reservation time of one hour, which is not shown) may also be included in the reproduction list. A program like the program Z can be viewed/listened after video-recording. Even if the program cannot be viewed/listened, the program may be included in programs to be extracted and incorporated in the reproduction list if following-up reproduction of the program allows viewing/listening of the program.

In this manner, in carrying cut one of methods of selecting a program, an unaccumulated program of which reserved video-recording is in progress is also included in programs to be extracted, so that the user is allowed to view/listen a program that is reserved by video-recording reservation. Such a program is selected in priority and is used for scheduling to allow the user to view/listen a program with video-recording reservation set therefor as soon as possible.

In the embodiment described with reference to FIGS. 12 to 14, a plurality of reproduction lists may be generated to allow user selection. In addition, a process as a combination of the embodiment described with reference to FIGS. 12 to 14, the embodiment described with reference to FIGS. 2 to 6, and/or the embodiment described with reference to FIGS. 7 to 11 may also be possible. In such a process, storing information necessary as program information in the accumulating portion 15 and determining the priority order of reference to items in the program information in advance allows extraction of a program and generation/display of a reproduction list in accordance with the priority order. For example, when a program with a reservation time runs out, the process of the embodiment described with reference to FIGS. 2 to 6 and/or the process of the embodiment described with reference to FIGS. 7 to 11 may apply for selection of a program to be selected next.

As described above, the present invention may adopt the form of a content video-recording/reproducing method including procedures described in the above embodiments and of a computer-readable reproduction list generating program for executing the procedures. The reproduction list generating program to be installed in the recording/reproducing apparatus is the program that causes such a processor as CPU to execute the procedures, and is the program that causes such a processor as CPU to function as the above means (the viewing/listening time setting means, the reproduction list generating means, and, preferably, a means that executes a recording process on a storage device in the reproducing time recording means, the partial viewing/listening information recording means, and the date/time recording means).

This reproduction list generating program is distributed as a program recorded on a computer-readable recording medium or is distributed through a network. A recording medium having recorded thereon programs and data for actualizing the functions of the present invention, specifically, is provided in the form of various assumable media, such as CD, MO (Magnetic Optical Disc), DVD, FD, flash memory, and other ROMs and ROMs. The above recording medium is attached to an information processing apparatus, such as a computer, to cause the information processing apparatus to read out the reproduction list generating program. In another case, the reproduction list generating program is stored in a memory device built in the information processing apparatus or in a recording/reproducing apparatus, such as a recorder as a data transfer destination, and is read out as the need arises. In this manner, the reproduction list generating function of the present invention is actualized.

1. A content recording/reproducing apparatus having a content accumulating means that records and accumulates content and a content reproducing means that reproduces accumulated content accumulated in the content accumulating means, comprising:
a reproducing time recording means that records reproducing time information indicative of a time needed for reproduction for each of the accumulated content;
a partial viewing/listening information recording means that records a content to be partially viewed/listened among the accumulated content and a part of the partially viewed/listened content to be viewed/listened as partial viewing/listening information;
a viewing/listening time setting means that allows a user to set a viewing/listening time representing a time span during which the user desires content viewing/listening; and
a reproduction list generating means that extracts a reproduction candidate content referring to the reproduction time information and the partial viewing/listening information so that the reproduction candidate content falls within the viewing/listening time set by the viewing/listening time setting means to generate a reproduction list.

2. The content recording/reproducing apparatus as defined in claim 1, wherein
the partial viewing/listening information recording means includes a reviewing/relistening information recording means that allows a user to set reviewing/relistening information indicative of a content to be reviewed/relistened among the accumulated content and of a part of the reviewed/relistened content to be reviewed/relistened to record the reviewing/relistening information as the partial viewing/listening information.

3. The content recording/reproducing apparatus as defined in claim 1, wherein
the partial viewing/listening information recording means includes a nonreproducing information recording means that records nonreproducing information indicative of a nonreproduced part of each of accumulated content reproduced by the content recording/reproducing apparatus as the partial viewing/listening information.

4. The content recording/reproducing apparatus as defined in claim 1, wherein
the partial viewing/listening information recording means includes:
a reviewing/relistening information recording means that allows a user to set reviewing/relistening information indicative of a content to be reviewed/relistened among the accumulated content and of a part of the reviewed/relistened content to be reviewed/relistened to record the reviewing/relistening information as one piece of the partial viewing/listening information; and
a nonreproducing information recording means that records nonreproducing information indicative of a nonreproduced part of each of accumulated content reproduced by the content recording/reproducing apparatus as one piece of the partial viewing/listening information.

5. The content recording/reproducing apparatus as defined in any one of claims 1 to 4, wherein
the reproduction list generating means refers to the partial viewing/listening information in priority over the reproducing time information, to extract a reproduction candidate content among content indicated by the information referred to so that the reproduction candidate content falls within the viewing/listening time set by the viewing/listening time setting means.

6. The content recording/reproducing apparatus as defined in claim 4, wherein
the reproduction list generating means refers to the reproducing time information, the reviewing/relistening information, and the nonreproducing information in a given priority order, to extract a reproduction candidate content among content indicated by the information referred to so that the reproduction candidate content falls within the viewing/listening time set by the viewing/listening time setting means.

7. The content recording/reproducing apparatus as defined in claim 1, wherein
the reproduction list generating means extracts in priority a content falling within the viewing/listening time and having a longer reproducing time as the reproduction candidate content.

8. The content recording/reproducing apparatus as defined in claim 1, comprising a list display means that displays the reproduction list generated by the reproduction list generating means and that checks with a user on whether or not to execute reproduction on the reproduction list, wherein
the content reproducing means executes reproduction of content included in the reproduction list only when acquiring a confirmation of execution of the reproduction through the list display means.

9. The content recording/reproducing apparatus as defined in claim 8, wherein
the reproduction list generating means generates a plurality of the reproduction lists, wherein
the list display means checks with a user on a reproduction list on which reproduction is to be executed among a plurality of reproduction lists generated by the reproduction list generating means, and wherein
the content reproducing means executes reproduction of only the content included in the reproduction list on which execution of reproduction is confirmed through the list display means.

10. The content recording/reproducing apparatus as defined in claim 1, comprising a date/time recording means that records a recording date/time of recording of the partial viewing/listening information and/or a recording date/time of recording of the content itself, wherein
the reproduction list generating means extracts in priority a content with a latest recording date/time recorded by the date/time recording means as the reproduction candidate content.

11. The content recording/reproducing apparatus as defined in any one of claims 2 to 4, comprising a date/time recording means that records a viewing/listening date/time of viewing/listening of the content indicated by the partial viewing/listening information, wherein
the reproduction list generating means extracts in priority a content with a latest viewing/listening date/time recorded by the date/time recording means as the reproduction candidate content.

12. The content recording/reproducing apparatus as defined in claim 1, wherein
the viewing/listening time setting means allows a user to set a time span the user desires content viewing/listening as the viewing/listening time together with information of a start time to start reproduction, and wherein
the reproduction list generating means also extracts a content that is not accumulated in the content accumulating means at present and that is scheduled to be accumulated by the start time or by an end time given by adding the time span to the start time as the reproduction candidate content.

13. The content recording/reproducing apparatus as defined in claim 12, wherein
the reproduction list generating means extracts in priority a content that is not accumulated in the content accumulating means at present and that is scheduled to be accumulated by the start time or by the end time as the reproduction candidate content.

14. A content recording/reproducing method in which a content reproducing means reproduces accumulated content accumulated in a content accumulating means, comprising the steps of:
a reproducing time recording means recording reproducing time information indicative of a time needed for reproduction for each of the accumulated content;
a partial viewing/listening information recording means recording a content to be partially viewed/listened among the accumulated content and a part of the partially viewed/listened content to be viewed/listened as partial viewing/listening information;
a viewing/listening time setting means allowing a user to set a viewing/listening time representing a time span during which the user desires content viewing/listening; and
reproduction list generating means extracting a reproduction candidate content among the accumulated content referring to the reproduction time information and the partial viewing/listening information so that the reproduction candidate content falls within the viewing/listening time set by the viewing/listening time setting means, to generate a reproduction list.

15. A program to be installed in a content recording/reproducing apparatus having a content accumulating means that records and accumulates content, and a content reproducing means that reproduces accumulated content accumulated in the content accumulating means, the program causing a processor in the content recording/reproducing apparatus to execute:
a reproducing time recording step of recording reproducing time information indicative of a time needed for reproduction for each of the accumulated content;
a partial viewing/listening information recording step of recording a content to be partially viewed/listened among the accumulated content and a part of the partially viewed/listened content to be viewed/listened as partial viewing/listening information;
a viewing/listening time setting step of allowing a user to set a viewing/listening time representing a time span during which the user desires content viewing/listening; and
a reproduction list generating step of extracting a reproduction candidate content among the accumulated content referring to the reproduction time information and the partial viewing/listening information so that the reproduction candidate content falls within the viewing/listening time set at the viewing/listening time setting step and generating a reproduction list.
